(19) United States
(12) Patent Application Publication
(10) Pub. No.: US 2026/0005869 A1
(43) Pub. Date: Jan. 1, 2026

(54) 3D-Printed ROM

(71) Applicant: Padraig Eoin-Pol O'Rourke, Dundalk (IE)

(72) Inventor: Padraig Eoin-Pol O'Rourke, Dundalk (IE)

(21) Appl. No.: 19/215,254

(22) Filed: May 21, 2025

(30) Foreign Application Priority Data
Jun. 10, 2024 (US) 63657993

(51) Int. Cl. H04L 9/32; G06F 21/57; G06F 21/78; G06F 21/86; H04L 9/14

(52) U.S. Cl. CPC H04L 9/3242; G06F 21/577; G06F 21/78; G06F 21/86; H04L 9/14; G06F 2221/034

(57) ABSTRACT

A write-once, read-many times (WORM) memory medium fabricated using 3D printing, additive manufacturing, or similar automated techniques is disclosed. The memory is structured as a diode matrix in which memory states are stored physically at intersections of address and data lines. These intersections are created using materials with differing electrical properties to produce fixed high or low states. The fabrication system may use arrays of ejection nozzles or other deposition mechanisms to enable practical write speeds. Applications include secure storage of cryptographic keys, hash values, and identity credentials. Additional embodiments include secure computing systems, secure communication devices, and hardware-based authentication mechanisms using the fabricated WORM memory as a tamper-resistant medium.

### 1. CROSS-REFERENCE TO RELATED APPLICATIONS

This application claims priority to U.S. Provisional Patent Application No. 63/657,993, filed Jun. 10, 2024, titled “3D-Printed ROM,” by the same inventor, Padraig Eoin-Pol O'Rourke.

### 2. BACKGROUND-PRIOR ART

This invention relates to data storage systems and, more specifically, to write-once, read-many times memory (WORM) fabricated using 3D printing and other additive manufacturing techniques. It further relates to applications in secure data storage, cryptographic key protection, device identification, and tamper-resistant code storage.

### 2.1 Introduction

Persistent digital data, that is data that remains intact after the device is turned off, and important records, are typically stored on rewritable data storage mediums. This allows the reuse of the memory space many times and is beneficial in many cases.

While such media allow memory to be reused many times, and that is advantageous in general-purpose computing, there are important use cases where immutability is preferred. In these cases, data should be written once and remain unaltered thereafter.

To simulate this immutability requirement, systems often rely on software controls or additional subsystems layered over inherently rewritable memory. This adds cost, complexity, and potential vulnerabilities.

Examples of scenarios where immutable data is preferred include the following listed directly below:
1. Financial, Legal, and Identity Records;
2. Legal Contracts;
3. Document Revision Management Systems;
4. Communication Records such as legal e-mails, and transmittals;
5. Computer Programming Code, or Machine Instructions partially controlling critical or secure systems; and
6. Randomly generated number sequences used as content verification hashes or encryption keys (i.e., nonces).

Most or all rewritable data storage media possess inherent physical limitations, including but not limited to the following:
1. Limited lifespan and reliability—These devices are subject to wear and eventual failure, with both complete and partial data loss becoming more likely over time.
2. Data degradation—Stored data may decay, with bits becoming unreadable or spontaneously flipping state due to charge leakage, magnetic fading, or other physical effects.
3. Environmental sensitivity—Rewritable media are often vulnerable to external factors such as electromagnetic interference, extreme temperatures, mechanical shocks, power surges, and outages.

Due to these vulnerabilities, such media require constant monitoring, maintenance, and protective systems. Furthermore, their ability to be rewritten makes them susceptible to accidental or malicious data modification.

Data storage systems typically require multiple mitigation strategies to preserve data integrity and reliability over time. Common techniques include:
1. Redundancy—Duplicating data across multiple media types and geographic locations to safeguard against localized failure.
2. Error detection and correction—Implementing error-correcting codes (ECC) to identify and, in some cases, automatically repair corrupted data. Additionally, deteriorating sectors must be monitored and migrated, and defective storage components replaced.
3. Data refreshing—Periodically rewriting data to prevent degradation from bit rot or medium instability.
4. Controlled environments—Maintaining storage media in regulated conditions to shield against temperature extremes, electromagnetic interference, physical vibration, and mechanical shocks.
5. Cryptographic integrity checks—Employing techniques such as hash computation and block chaining to detect unauthorized alterations. However, these measures still rely on external validation mechanisms, which themselves must remain secure and uncompromised.
6. Human oversight—Engaging a trusted team of engineers and technicians to monitor, maintain, and manage the system's integrity and functionality.

### 2.2 Write Once Read Many Times Memory

Write-Once, Read-Many Times (WORM) memory systems exist but remain limited in widespread adoption. It has been suggested in some professional and academic settings that certain religious, guilds, fraternal, intelligence, or professional groups may view the concept of immutable data storage unfavourably. Anecdotal commentary in industry circles has speculated that the acronym “WORM” may have been chosen or interpreted in a way that subtly discourages its use, by invoking negative connotations.

Presently, most commercially deployed WORM systems are software-based, relying on file system- or object-level controls to enforce data immutability, rather than using true physical write-once media. These systems provide logical enforcement of retention policies and are commonly used in enterprise archiving, compliance, and long-term digital preservation. Examples of such systems and their technical implementations are detailed in the following patent documents:
US20060095553A1—Storage system, Hitachi, Ltd.
Describes a storage architecture with preservation period management and compliance functionality.
U.S. Pat. No. 11,700,214B2—Information processing apparatus and storage system, Hitachi, Ltd.
Covers integrated systems for secure and policy-driven storage management.
U.S. Pat. No. 7,958,166B2—System and method for providing write-once-read-many (WORM) storage, IBM
Details WORM enforcement using software policies on rewritable media.
U.S. Pat. No. 8,200,721B2—Continuation of above, IBM
Expands on techniques for ensuring non-erasable data retention through software means.
US20200034451A1—Data deduplication for elastic cloud storage devices, EMC IP Holding Co LLC
Illustrates deduplication and storage control in a cloud-native WORM-capable environment.
U.S. Pat. No. 10,929,424B2—Cloud replication based on adaptive Quality of Service, Veritas Technologies LLC
Describes storage and replication systems supporting WORM and retention-sensitive data handling.
U.S. Pat. No. 11,409,604B2—Storage optimization of pre-allocated units of storage, Veritas Technologies LLC
Discusses optimization of storage with WORM-compatible features and logic.

Due to increasing legal and regulatory demands, there is sustained and growing need for secure, tamper-resistant WORM storage systems. A number of regulations across industries specifically mandate or favour the use of WORM-capable solutions, as outlined below:

### Regulatory and Compliance Requirements Supporting WORM Storage

1. SEC Rule 17a-4(f)—U.S. Securities and Exchange Commission
   Requires that broker-dealers preserve certain electronic records in a non-rewritable, non-erasable format. WORM storage is specifically cited as an acceptable method.
      →Reference: 17 CFR § 240.17a-4 (f)
2. FINRA Rule 4511 (c)—Financial Industry Regulatory Authority
   Mandates retention of records in a format compliant with SEC Rule 17a-4, thereby requiring immutable storage for certain records.
      →Reference: FINRA Manual—Rule 4511
3. CFTC Regulation 1.31 (c)—Commodity Futures Trading Commission
   Requires that required records be stored in a manner that protects against erasure or alteration, and remain accessible for the required retention period.
      →Reference: 17 CFR § 1.31
4. HIPAA 45 CFR Part 164—Security and Privacy Rules-U.S. Department of Health and Human Services
   Requires healthcare providers and related entities to ensure the integrity and non-repudiation of electronic protected health information (ePHI). WORM storage helps meet these safeguards.
      →Reference: 45 CFR § 164.312(c)
5. FDA 21 CFR Part 11-U.S. Food and Drug Administration
   Governs electronic records and signatures in medical, pharmaceutical, and life sciences industries. Requires that records be protected from unauthorized alteration.
      →Reference: 21 CFR § 11.10(c)
6. GDPR Article 5(1)(e)—EU General Data Protection Regulation
   Requires data to be stored in a way that prevents tampering and ensures accuracy, especially during long-term retention.
      →Reference: Regulation (EU) 2016/679
7. Sarbanes-Oxley Act (SOX) Section 802—U.S. Corporate Financial Accountability Requires accurate retention of audit records and prohibits deletion or falsification of records. WORM media is often used to demonstrate compliance.
   →Reference: U.S. Public Company Accounting Reform and Investor Protection Act, Section 802
8. ISO/IEC 27001 & 27040—Information Security Management Standards
   These standards recommend the use of tamper-resistant storage to ensure data integrity in archival and backup systems.
      →Reference: ISO/IEC 27040:2015—Storage Security

Historically, earlier WORM technologies, such as mask ROM, focused on the mass production of identical memory units. In these systems, data was permanently encoded during the semiconductor manufacturing process, making it impossible to modify. While extremely cost-effective for high-volume production—such as game cartridges, firmware for appliances, and consumer electronics-τhese methods are economically impractical for low-volume or individualized data storage due to the fixed cost of lithographic mask creation and production setup.

### 2.3 Secure Memory

Current methods of storing data with secure requirements suffer from a variety of potential attacks. Most can be reprogrammed without having to physically replace or modify the existing physical chip. Data that needs to be zeroed or deleted after use may still be readable either by dismantling the chip or reading subtle residue properties using modern 3D imaging techniques, or a combination of these methods.

In order to guarantee the data is unrecoverable physical destruction of the device by a technician typically in a lab or workshop environment is required.

### 2.4 Secure Electronics or Computer Code

Many modern devices have software, and some hardware security features. However, the software is held on rewritable data storage mediums. In most cases there is little to stop malicious modification of the code controlling these security features. The Operating System may provide some security features around the code running the programs. But the code to run the operating system may be modified. The startup code, or BIOS may provide security features around the code content of Operating Systems, but the Startup Code, or BIOS can also be changed.

These security vulnerabilities are ignored with the often cited rational being either. There are so many possible vulnerabilities, that protecting against these vulnerabilities has little effect.

The second rational is the error rate at which computer code is produced is too high, and the ability to modify code in field over the cost of replacing entire systems infield is a sufficient advantage that overrides these security concerns.

Some public examples of “firmware” and memory based attacks are listed below:
UEFI Rootkits: Threats like MoonBounce and LoJax inject code into UEFI firmware, executing before the OS loads. These rootkits persist in SPI flash even after disk wipes or OS reinstalls.
LogoFAIL (2023): Exploits vulnerabilities in UEFI logo handling to inject malicious boot-time code. It impacts many devices and is difficult to detect or remove.
Cold Boot Attacks: By rebooting a system and accessing RAM quickly, attackers can recover encryption keys and sensitive data before it fades.
Charge Decay Analysis: Reads residual electrical states in memory to recover data thought to be deleted, posing a risk to data confidentiality.

### 2.5 Data Validation

Even the strongest data-validation schemes are undermined if the underlying platform isn't truly secure—as mentioned in the previous section, you can swap out the BIOS, replace the operating system, or load a rogue browser or application and bypass every check. In theory, data-validation defends against in-transit tampering, deepfakes, and forged records; in practice, an attacker who controls firmware or code can neutralize it entirely.

Validation techniques commonly deployed today include:
Digital signatures & checksums on documents, code, and media (PGP, Authenticode)
Transport-layer security (HTTPS/TLS) to authenticate servers and protect data in transit
Content-provenance metadata (C2PA/Content Authenticity Initiative) for images and video
Signed package manifests and transparency logs (Sigstore/Rekor) in software supply-chains
Blockchain-anchored timestamping (OpenTimestamps) for immutable proof of existence

These methods can detect or prevent unauthorized edits—but only if the verification code itself is trusted. Once an adversary can reflash your boot firmware, subvert the OS kernel, or swap out the validation libraries, every checksum, signature check, or provenance tag becomes moot. In other words, without hardware and firmware you can't trust, data-validation is fundamentally all for nothing.

Some intelligent data validation methods exist. Approaches typically rely on static rule sets, format checks, and basic range enforcement. While these may be sufficient for benign environments or simple applications, they often fail to detect subtly manipulated data designed to appear plausible, particularly when adversaries have access to internal system knowledge or are able to exploit machine learning models and automated decision-making systems.

Such interference may occur at various stages of the data lifecycle: during acquisition, transmission, processing, or storage. Attackers may exploit weak or non-existent validation protocols to inject fabricated data, manipulate real-time inputs, or tamper with datasets post-collection—all without triggering detection mechanisms.

The rise of synthetic data, deepfake technologies, and automated content generation further exacerbates these risks, enabling malicious actors to insert false but contextually convincing data into scientific studies, media streams, or public datasets. In the long-term current cryptographic methods limitations may be exploited.

I have witnessed instances where religious, fraternal, intelligence groups and or guilds have modified content from: inheritance wills; telephone voice calls; newspapers; video in acted out court hearings in an official court room; radio and TV, programs and advertisements; e-mails; postal services; medical records; business contracts; and internet pages. Also issues with Identify theft, false credentials, false deaths, and many record systems such as those used to manage seating arrangements on aeroplanes.

Some describe our times as the post truth world, where wars can be started, and pandemics occur all under suspicious and often illogically reasoning, presented by narrowly channeled media coverage.

### 2.6 Private Key Encryption

Cryptographic systems have long relied on secret keys to transform sensitive data into unintelligible ciphertext and back again. Methods known since antiquity such as the one-time pad, achieve perfect secrecy by combining each message bit with a truly random key bit that is never reused. In practice, however, securely generating, distributing, and storing such enormous key volumes proved impractical, and the one-time pad gave way to more manageable symmetric-key ciphers (e.g. DES, later AES), in which a single shared secret is used repeatedly under carefully controlled modes (CBC, CTR, GCM) that incorporate nonces or initialization vectors to prevent key reuse attacks.

To protect long-lived keys, hardware security modules (HSMs) and secure elements embed key material in tamper-resistant ICs or battery-backed memory. These solutions guard against software vulnerabilities and physical probing, but still depend on manufacturers provisioning each device with the correct secret—and can be expensive at scale. Meanwhile, asymmetric (public-key) schemes (e.g. RSA, ECC) alleviate key-distribution challenges by separating encryption from decryption keys, yet impose heavier computational and code-size burdens that limit their use in constrained devices.

While public key encryption appears reliable to the public and has become a foundational element of modern cryptography, it suffers from inherent weaknesses that limit its long-term security and practicality.

Public key algorithms depend on the computational difficulty of problems like integer factorization or discrete logarithms, making them vulnerable to advances in hardware and algorithmic efficiency—especially with the anticipated rise of quantum computing. Moreover, public key systems typically rely on relatively short key lengths (e.g., 2048-4096 bits) due to performance constraints, which further restricts their resilience against future attacks.

More recently, techniques such as Physically Unclonable Functions (PUFs) and fuse-or-eFuse-based one-time programmable bits have exploited manufacturing variations or permanent programmable changes to derive or lock keys in silicon. Such hardware-rooted secrets can be extremely large—extending into megabits or even gigabits—but existing PUFs are often noisy, and eFuses offer only limited capacity.

Despite this progress, there remains a need for a low-cost, massively scalable way to embed truly one-time, high-entropy secrets directly into a device's fabrication process—without relying on post-manufacture programming or complex key injection.

Prevalent private and public key methods:
Data Encryption Standard (DES)
   DES was formalized in 1977 by IBM and adopted as FIPS 46-3. It is a 64-bit block cipher built on a Feistel network. The foundational IBM patent (often called LUCIFER) is

U.S. Pat. No. 3,798,359 A—“Block Cipher Cryptographic System” (Horst Feistel, 1974).
Advanced Encryption Standard (AES)
   AES (originally the Rijndael algorithm) was selected by NIST in 2001 as FIPS 197 and supports 128-, 192-, and 256-bit keys on 128-bit blocks. See:

FIPS 197—Advanced Encryption Standard (AES), NIST.
RSA Public-Key Cryptosystem
   RSA separates encryption and decryption keys and is widely used for key exchange and digital signatures. The U.S. patent is

U.S. Pat. No. 4,405,829 A—“Cryptographic Communications System and Method” (Rivest, Shamir & Adleman, 1983.)
Elliptic-Curve Cryptography (ECC)
   ECC achieves similar security to RSA with much shorter keys by working over algebraic curves. A representative hardware-friendly patent is

U.S. Pat. No. 6,618,483 B1—“Elliptic Curve Encryption Systems” (describing finite-field normal-basis implementations), 2006.

### 2.7 Remote Device, Product and Personal Identification Systems, And Door Locks

Currently PC's possess a unique identifier that can be mimicked by another device. So, there is no means to verify their identity across a network. Many coded software methods for identifying a computer exist but can all inherently be cloned. So, the manufacture, a government organisation, or any organisation cannot be sure what computer they are communicating with over a network.

Also, while many hashing, and cryptographic methods exist there is nothing stopping malicious cloning of a PC's operating systems, and programs appearance. Then giving the appearance to the user that communication has been encrypted, or content verified by hashing when in fact it has not.

Door Locks, and ID Radio Frequency Identification (RFID) systems typically rely on small kilobyte size memories, and smaller keys. Encryption is sometimes used but are repeatedly compromised with such frequency it is reasonable to speculate the desire of religious, fraternal, intelligence groups and or guilds to retain the ability to gain access to private property as an influence to the rationale behind design decisions.

Existing electronic access control systems, including RFID fobs, proximity cards, and mobile credential technologies, are known to suffer from significant security vulnerabilities. Low-frequency systems, such as 125 KHz HID Prox cards, transmit static identifiers without encryption, making them susceptible to cloning through easily accessible tools. Similarly, early high-frequency systems like MIFARE Classic have been compromised due to weak proprietary encryption, allowing attackers to duplicate cards with minimal equipment. Physical security lapses in hotel locks and other commercial access points have enabled unauthorized entry through firmware manipulation or exposed diagnostic ports. Additionally, Bluetooth Low Energy (BLE) and NFC-based mobile access systems have been subject to relay and replay attacks, where adversaries simulate the presence of a legitimate credential using relayed signals. These and other known vulnerabilities in legacy and current systems highlight the ongoing need for improved methods of secure, tamper-resistant access control.

### 2.8 Early Rom

Very early read only memory (ROM) devices for computers or just programmable machines used punch cards, or a battery of electrical switches to store an instruction list, or non-volatile constant data. Relays where later used in machines like the Z3.

An often-overlooked ROM type named diode matrix memory was prevalent for a time. A simple early diode matrix used a 2D grid of wires. In the grid a 2D-plane containing the row wires and offset a small distance a 2D-plane containing the column wires so that the row wires do not touch the column wires. This forms a grid of wires with a gap with a small gap at the intersection points of the grid. Using the rows as address lines and columns as data lines, the intersection become a place where a bit of data can be stored. By physically soldering in diodes by hand at the intersections a high bit could be represented. Leaving a gap at an intersection could represent a low bit. Layers of these grids of wires can be stacked on top of each other to increase capacity of the systems.

One of the earliest patents and possibly the first for using a grid of wires was for the first random access memory in the Whirlwind I system developed by the United States Air Force in 1951. This system utilized an addressing method that led to the development of matrix core memory, one of the earliest forms of Random Access Memory (RAM). This innovation is documented in US Patent U.S. Pat. No. 2,736,880A, titled “Multicoordinate Digital Information Storage Device”.

Earlier military projects used diode matrix memory but patents came later and not in a definitive clearcut way. Below are list the three most relevant earliest patents.
1. U.S. Pat. No. 3,004,253A (Filed: 1958, Published: 1961)
   “Diode Matrix Memory”—Describes a ROM matrix using diodes for permanent data encoding.
2. U.S. Pat. No. 3,296,510A (Filed: 1964, Published: 1967)
   “Diode Matrix”—More refined and programmable forms of diode-based memory systems.
3. U.S. Pat. No. 2,953,704A (Filed: 1956)—“Diode memory circuit”—Describes the electrical implementation of diode-based logic and memory.

Many forms of ROM and non-volatile memory for computer machinery have been developed in the interim. Mostly either based on silicon wafer based semi-conductors, magnetic, or optical. These have been developed with ever increasing capacities, and ever decreasing dimensions, and mass. These methods have many advantages over handmade resistive matrix ROMs and so diode matrix memory went into disuse as an external ROM. It is still used in microprograms of CPU's.”

### 2.9 Solid-State ROM

Usually refers to all ROM variants built using photolithography, doping, deposition on silicon.

### 2.9.1 Mask ROM

Mask ROM is often diode matrix memory on silicon, or a slightly different configuration on silicon. It is smaller, lighter, faster, and more cost effective than all other memory types provided you are mass producing many identical state ROMs. This is the result of significate templating costs for each ROM's state produced. The photolithography process used requires the manufacture of an expensive templating mask. Risk of error in programming resulting in a faulty template or mask, and the inability to update deployed software updates is often given as a reason for not using this type of ROM often. This is despite the significate added security provided, by virtually eliminating the ability to deceitful modify code contained on the ROM if packaged securely with the processing unit. Mask ROM is also very fast to the point where it can be read in the same clock cycle as the CPU similar to cache as a result it is often used in the microprograms of high-end CPU's. Apart from CPU Micro Code, and Game consoles from the 1980's it occasionally get used in Boot ROM for Secure System on a Chip systems, and firmware in industrial appliances.

### 2.9.2 Programmable ROM (PROM)

Programmable Read-Only Memory (PROM) addresses the high cost of traditional ROM by allowing post-manufacture programming. Initially, all memory cells are in a uniform state (e.g., all ‘1's). Using high-current or high-voltage pulses, selected cells are fused or blown to change their state, providing write-once, read-many (WORM) functionality.

However, PROM is not entirely secure. Some designs allow unidirectional bit changes, which, though limited, can be exploited for malicious purposes. For example:
U.S. Pat. No. 7,924,596B2—Area-Efficient PROM is susceptible to such attacks.
U.S. Pat. No. 4,238,839A—Laser-Programmable ROM, on the other hand, does not permit post-programming changes, offering better integrity.
   2.9.2.1 Electrically Erasable Programable ROM (EEPROM), Flash memory, and Solid state NAND memory

These have largely replaced PROM. These forms of memory can be written to a number of times and read from a great many more times. But in relation to this use case have the following disadvantages:
1. Susceptibility to Unauthorized Modification: Their rewritable nature allows for potential unauthorized alterations of data and control programs.
2. Limited Lifespan: They have finite write/erase cycles and retention periods, making them unsuitable for long-term archiving.
3. Environmental Sensitivity: They are vulnerable to heat, electromagnetic pulses, and physical shocks.
4. Maintenance Requirements: They necessitate periodic integrity checks, data refreshing, and data relocation from degraded sectors where errors occur.

U.S. Pat. No. 7,489,005B2: EEPROM with nonvolatile memory cell

U.S. Pat. No. 5,602,987A: Flash EEPROM system

U.S. Pat. No. 8,233,325B2: NAND flash memory

2.9.3 Magnetic disks, tapes, and Hard drives:

Magnetic systems have their advantages, but in general as write once read many times secure archival devices suffer to varying extents in the same ways as EEPROM, Flash, and SSD. They typically also have high error rates and require extensive hashing error codes, and even copying out of large bad or unreliable sectors of the recording medium as time goes by. As they are magnetic, electro-magnetic pulse destroys them.

Relevant patent: U.S. Pat. No. 5,313,357 A (“Magnetic storage device and manufacturing method thereof”).

### 2.9.4 Optical Disks (CD, DVD, Blue-Ray)

Where initially suggested to have very long 50-100 years, and even indefinite life spans. However, they are now considered to have a life span of 20-50 years. This may be the result of poor manufacturing rather than the technology itself. Scratching of the read surface that would not be a problem in an enclosed environment leads to data loss.

When it comes to archiving data many of these methods small, and lightweight nature increases the risk of sleight of hand or switch them out securities concerns by malicious technicians or others.

Similarly, fast write times allow for quick in-facility replication with modification, presenting a security issue.

Relevant patent: U.S. Pat. No. 9,741,390 B1-Optical disc drive

### 2.10 3D-PRINTING AND ADDITIVE MANUFACTURING TECHNIQUES

Since Chuck Hull's seminal 1986 patent on stereolithography (U.S. Pat. No. 4,575,330 A)—the first practical 3D-printing method—a host of additive processes have been developed:
Stereolithography (SLA) uses a UV-curable resin that hardens layer by layer to build complex shapes
Fused Deposition Modeling (FDM) extrudes thermoplastic filament through a heated nozzle and deposits it in successive beads.
Thermal Inkjet (drop-on-demand) ejects droplets by explosive vapor-bubble formation, as first described in U.S. Pat. No. 4,490,728.
Piezoelectric Inkjet uses a piezo actuator to force material jets with nanoliter precision (see U.S. Pat. No. 6,318,828 B1 for firing-control methods).
Binder Jetting selectively deposits a liquid binder onto a powder bed to join particles.
Powder Bed Fusion (Selective Laser Sintering/Melting) fuses powdered materials via a laser or electron beam.
Multi-material printheads—where individual heads maintain independent temperatures for different materials—are taught in U.S. Pat. No. 7,195,475 B2.

### 2.10.1.1 More Recently, 3D Printing of Electronic Circuits

Active electronic materials (semiconductor inks, liquid-metal leads, polymer matrices) can be printed in a single sequence (U.S. Pat. No. 9,887,356 B2).
Embedded PCB printing platforms (e.g., Voxel8) enable concurrent deposition of copper and dielectric for on-demand circuit fabrication.
3D-printed batteries and energy storage architectures, such as Harvard's all-printed microbatteries, are covered under EP 3,231,020 A1.

### 2.10.1.2 Additional Relevant Patents

U.S. Pat. No. 8,467,620 B2—Aerosol-Jet® micro-dispensing for fine-scale printed electronics
US 2014/0201919 A1—Functional inks and materials for additive manufacturing
U.S. Pat. No. 9,360,631 B2—Direct-write 3D batteries
U.S. Pat. No. 10,812,789 B2—Integrated 3D-PCB printing platform
U.S. Pat. No. 10,149,889 B2—Multi-material jetting system for electronic assemblies

### 3. SUMMARY

This disclosure relates to the 3D-Printing, additive manufacturing, or other manufacturing methods of mediums that store data typically with limited rewrite capabilities. Data states are stored at the intersection of address lines and data lines in a 3D-Matrix. Several resulting applications are also disclosed.

Embodiments of the device used to create the memory would lightly utilize numerous batteries of ejection nozzles, assemblers, or dispensers to increase write speeds to practical levels.

In various embodiments, the fabrication system may use multiple arrays of ejection nozzles, assemblers, or dispensers to increase write speeds to practical levels. The resulting memory stores data as fixed physical material, rather than in fragile states such as charge, magnetism, or optical reflectivity, offering resilience to temperature fluctuations, electromagnetic interference, data decay, and physical impact.

### 3.1.1 Write Once Read Many Times

In one embodiment, 3D-Printed ROM consists of a solid block comprising conductive wire matrices, insulating resin, and printed diodes. Connections between address and data lines are established via printed diodes to indicate a high state, while insulating material at intersections represents a low state

In another embodiment, 3D-Printed ROM consists of pre-assembled solid-state components (e.g., diodes, transistors) at the intersections instead of printed electronics. The quality and consistency of such components influence both the reliability and capacity of the memory.

Additional embodiments may include the use of:
Capacitors at intersections, read using alternating current;
Optical isolators at intersections, read using electromagnetic signals through materials such as optical fiber.

### 3.2 Secure ROM

For some use cases, it is advantageous to delete stored data after use. For example, encryption keys should not be recoverable after they have served their purpose. Since ciphertext can be intercepted and stored indefinitely, eliminating the key ensures future decryption is impossible.

### 3.2.1 Write Once Read Once

One embodiment places a diode and a fuse in series at each intersection. Low bits are represented by pre-blown fuses, while high bits are left intact and then blown during the read operation. Afterward, all fuses are physically identical, preventing differentiation-even by invasive physical examination.

### 3.2.2 Destroyable ROM

In another embodiment, memory destruction is triggered by altering the properties of the insulating structural material supporting the data storage matrix from an inert substance to a corrosive or destructive one to destroy part or all of the memory block. Embedded acids or energetic compounds like C4 are potential candidates here.

### 3.2.3 Erasable WORM

In another embodiment integrates a secondary circuit capable of disabling specific data or address lines, rendering portions of the memory unreadable.

### 3.2.4 Erasable Programable Read Many Times Memory

In another embodiment data allowed to be written once to blank memory and then erased (zeroed) selectively through a controlled circuit.

### 3.3 Secure Electronics and Computing

In one embodiment, a general-purpose processor executes all firmware and system code stored in 3D-Printed ROM, with volatile RAM for runtime data.
Immutable code base: Bootloader/BIOS, core OS modules, and security-sensitive routines (e.g. crypto engines, validation libraries) reside entirely in ROM rather than on rewritable media.
Private internal bus: All inter-component communication (processor↔ROM↔RAM↔crypto module) occurs on an internal bus inside the secure casing.
Controlled external interfaces: Any connection to the outside world (I/O buses, network ports, wireless links) is mediated by hardware logic within the enclosure to enforce authentication and access policies.
Tamper proof secure casing such as fibre optics encasing as seen insecure casing for electronics is patented in U.S. Pat. No. 7,518,507 B2 dated April 14^{th} 2009 titled Method and System to Detect Tampering of a Closed Chassis using a Passive Fiber Optic Sensor.

### 3.3.2 Secure Circuit Configuration

Where minimal functionality or lower power is required, the entire system may be implemented as fixed-function electronics: no general-purpose CPU, just hard-wired logic and security functions in 3D-Printed ROM. This trades software flexibility for:
Reduced bill-of-materials and production cost
Smaller physical footprint and lower power draw
Simpler validation of correct behaviour

### 3.3.3 Dripping Keys

A “dripping key” is a typically a sequence of nonce values (identical random values across two or more secure devices) that are revealed (“dripped”) over time or usage according to predefined rules (e.g. at fixed intervals, upon authenticated requests, or based on stored counters). These synchronized nonces can be used for:
Private-key encryption—each nonce serves as a one-time key for symmetric encryption, yielding perfect forward secrecy without key distribution.
Data validation-nonce—keyed message hashes bind content to a time or usage epoch, preventing replay or data forgery.
Remote device authentication—matched nonces across claimant and verifier devices enable fast, mutual proof of identity.

Because the nonces are embedded in immutable, tamper-resistant ROM and never exposed until “dripped,” they cannot be cloned or reprogrammed-so each device pair or group maintains a synchronized yet irrevocable secret.

### 3.4 Data Validation

Another embodiment utilises dripping keys, trusted server, and hashing methods to validate the authenticity of data across a network. The method is used in other embodiments to validate document revisions, personal approval or involvement, device used in preparing data, and other details.

### 3.5 Private Key Encryption

Another embodiment uses as a single, or low production run of ROM, this embodiment allows deployment of many long cryptographic keys. These long cryptographic keys can be periodically used to secure private communication, verification of integrity of communication, and verify the identity of a remote device.

### 3.6 Remote Device, Product and Personal Id Systems, and Door Locks

Another embodiment uses the unique nature of a key to verify the identity remote device in the form of a bracelet. The person wearing the bracelet is therefore also identified. Various configurations of this embodiment can be extended to many applications including door locks or secure access.

### 4. Advantages

While existing forms of data storage are advantageous in many applications, the embodiments described in this disclosure provide numerous benefits across one or more aspects. Many of these advantages are listed directly below in suitable categories, organized approximaly by application type or functional grouping.

### A. As Durable, Write-Once Read-Many Data Storage Devices:

1. High data integrity and immutability increase system confidence. The rugged physical form makes the memory suitable for secure transactions, legal documents, and archival records—potentially more reliable than current paper-based methods.
2. Extremely long data retention—data remains secure and unchanged for decades, centuries, or longer. Effectively perpetual in operational lifetime.
3. Greater resilience to temperature fluctuations, electromagnetic interference, and physical shocks. Many embodiments are fire-resistant. While the control electronics may require replacement, the memory content remains intact.
4. Minimal reliance on blockchain-style verification software—reduces security vulnerabilities from additional software layers. Some minimal block-chaining may still be used.
5. Reduced need for complex error correction, with only minimal error-coding required. This reduces both software complexity and security risks.
6. Fewer redundant copies of sensitive data are needed due to lower risk of failure.
7. Monitoring software for corruption and sector failure can be minimized.
8. No need to physically replace faulty or end-of-life memory units, as the storage medium is permanent.
9. Permanent data storage devices can be made large and heavy, deterring covert removal or theft.
10. Physical visibility of data-holding media increases public trust. For instance, a 3D-printed ROM containing backup data could be displayed at banks or government facilities to demonstrate data integrity—making the data tangible and distinct from abstract “cloud” storage.

### B. Secure ROM

11. Low-volume or one-off production of physically immutable ROMs—ideal for securely storing cryptographic keys resulting from manufacturing methods.
12. Write-Once Read-Once (WORO) combines the rugged permanence and reliability of general 3D-Printed ROM with extremely reliable zeroing of used data.
13. Destroyable memory adds another layer of confidence to write once read once systems.
14. Erasable WORM memory offers sufficient security for most application where Write once read once, or destroyable ROM are unnecessary.
15. On-Demand, In-Field Manufacture No dependence on centralized wafer fabs or mask-sets—units can be printed at point-of-use (factory, depot, even forward operating base), eliminating long supply chains, reducing lead times and logistic footprints, and improving responsiveness to emerging threats or bespoke requirements

### 16. Form-Factor Flexibility

Because the memory is built layer-by-layer, it can conform to arbitrary shapes—curved surfaces, conformal patches, or even embedded directly into structural components—enabling seamless integration into anything from UAV airframes to wearable medical devices.

### C. Secure Electronics and Secure Code.

17. BIOS/startup code, critical OS components, and security features can be embedded in secure ROM, creating tamper-resistant devices.
18. Secure casing increases tamper resistant.
19. Heterogeneous Material Integration. Multi-material heads can allow you to co-print conductors, semiconductors, sensors, and even energy-storage elements (batteries, supercaps) in one build. This can collapse multiple subsystems (memory+power+sensing) into a single monolithic part.
   D. When used in a Data Validation system.
20. Increased confidence in reliability of the authentic and integrity of material viewed on device.
21. Reduces propaganda by dissemination of mass or individual tailored material.
22. Reduces Risk of Fraud by exposure to deceptive information designed to enable fraudulent manipulation of the individual or a system.
23. Reduces doctored evidence to deceive courts.
24. Increased confidence and reliability of raw or computed, data or measurements received for Scientific, or Engineering use or reporting.
25. Reduces AI modified content where subtly manipulated data designed to appear plausible using internal system knowledge, synthetic data, or deepfake systems.
26. Restores public trust in the integrity of records, communications, and systems essential to democratic free world providing security around legal documents, telephone calls, online news, and other media content, e-mails, government reports, and private company computing and information systems

### E. Private Key Encryption

27. Reduced dependence on public key infrastructure that may be void in the long term.
28. Very long private keys provided enhanced encryption algorithms.
29. Unbreakable encryption, when the message is the same length as the key appliable to voice calls, all text-based work, or communications such as e-mails, private messages, and so on.

### F. Remote Device, Product, or Personal Identification

30. Integrated Lifecycle Tracking. Printing on-chip serial numbers, QR codes or RFID antennas alongside the WORM matrix enables a single part to carry both its secure key store and its provenance/tagging metadata—simplifying audits and chain-of-custody without additional labels or barcodes. Remote tamper detection by manufacturer or suitable authority.
31. Built-In Anti-Counterfeiting
   Every print run—even of “identical” designs—will incorporate microscopic process-variation artifacts. Combined with embedded dripping-key sequences, this yields a hardware fingerprint that is virtually impossible to clone, even if someone steals your CAD files.
32. Secure, One-Time Authentication Without Replay Risk
   The use of nonce keys (unique, time- or session-based random values) ensures each authentication session is cryptographically distinct. This prevents replay attacks, since previous valid responses cannot be reused by malicious actors to gain access.
33. Device Uniqueness Without Central Credential Storage
   Devices can generate or store unique private keys internally and respond to nonce challenges in a way that proves identity, without requiring access to a central credential database. This decentralizes trust and reduces vulnerability to database breaches.
34. Tamper-Resistant Identity Validation
   When implemented with WORM memory or immutable embedded ROM, the stored private keys or validation logic cannot be altered post-manufacture. This makes identity validation secure even against physical compromise attempts.
35. Hardware-Bound Identity Tied to Manufacturing State
   The nonce-based challenge-response mechanism can prove that a specific, physically manufactured device is the one responding—useful for secure hardware authentication, anti-counterfeit measures, and supply chain validation.
36. Cryptographic Binding of Identity to Use Context
   Nonce keys can be derived from session-specific context (e.g., timestamp, session ID, application state), binding the identity proof not just to the device but also to the specific instance or user request. This adds contextual validation strength.
37. Scalable Across Billions of Devices
   The system allows for lightweight, scalable identification of devices with no need for per-device credential synchronization or ongoing secret exchange. Nonce-based mechanisms can be implemented in minimal logic or hardware, even in low-power devices.
38. Support for Multi-Factor or Mutual Authentication
   Nonce-based identity checks can be combined with secondary authentication steps, such as user input or biometric verification, or used for mutual authentication between two secure devices with known validation keys.

### G. Socially Beneficial

39. Forensic evidentiary confidence. Courts can accept digital logs, recordings or documents from WORM media as demonstrably untampered—greatly reducing challenges over chain-of-custody and forged evidence.
40. Verified media authenticity. Viewers can cryptographically confirm that a live news feed, recorded interview or photo truly originated from the claimed camera or broadcast studio—combatting deepfakes and “fake news.”
41. Election integrity. Ballots, voter rolls and audit trails stored on tamper-resistant WORM devices (even in 3D-printed form) become fully traceable yet unalterable, strengthening confidence in vote counts and reducing electoral fraud.
42. Allow more Direct Democracy features in Government. With every ballot cast, petition submitted, or public comment recorded immutably in tamper-resistant WORM media, citizens can vote or express opinions directly with confident that their inputs are recorded as intended and cannot be altered. Such a foundation of verifiable, end-to-end integrity makes large-scale referenda, crowdsourced policy initiatives, and more frequent and reliable public consultations practicable without sacrificing security.
43. Charity and grant transparency. Donors and regulators can track disbursement logs and impact reports on immutable media—making it harder for intermediaries to misappropriate funds and easier to demonstrate real social impact.
44. Supply-chain provenance. From fair-trade certification to drug authenticity, each handoff can be logged in write-once memory, creating an unbroken, verifiable record that deters counterfeiting and corruption.
45. Regulatory compliance made simple. Industries such as finance, healthcare or pharmaceuticals can archive transaction records and audit logs on certified WORM devices, turning regulatory reporting from complex software audits into straightforward media inspections.
46. Strengthened public trust. When individuals can independently validate news, legal filings, public health data or environmental sensors using immutable, verifiable media, confidence in institutions and shared information rises—helping to heal fractured social discourse.
47. Identify and Reduce Religious, Fraternal, Guiled, or Government Persecution. By keeping immutable and more accurate records and recordings, the system prevents any individual or organized group from secretly altering or erasing records to justify denial of care, coercion, or other rights-violating practices. Also, the perverted and deranged acting out sceneries in public to access a person's “character” can be eliminated, and participants prosecuted.
48. Identify and Reduce Religious, Fraternal, Guiled, or Government Acts of Terror and Political Theater. By capturing orders, communications, and security-relevant logs in tamper-resistant WORM media, every step of any violent or coercive campaign—whether orchestrated by extremist religious sects, clandestine fraternities, corporate guilds, or authoritarian state actors—becomes permanently auditable. As a result:
   i) Concealed planning is exposed. Secret directives to carry out terror attacks, political intimidation, or unlawful arrests cannot be back-dated or erased once written.
   ii) Chain-of-custody is unbreakable. Evidence collected from intelligence operations, law-enforcement interventions, or whistle-blower disclosures remains inviolate, making it far easier to prosecute conspirators.

### F. Other Applications and Considerations

49. Low-Waste, Environmentally Friendly. Additive processes minimize scrap: unused powder or resin can often be recycled, and there's no need for chemical etch or dicing losses. This reduces environmental impact compared to traditional lithography.
50. Rapid Iteration & Upgradability. Firmware-in-ROM can evolve simply by uploading a new print profile—no new masks or spin-outs—so even “write-once” keys can be rotated or extended over successive print runs.
51. Intrinsic EMP & Radiation Hardness. Dense, inorganic printed diodes and metal interconnects can be formulated with radiation-resistant materials (ceramics, glass) and packaged into low-susceptibility profiles, making them ideal for aerospace, nuclear, or hardened industrial applications.
52. Cost-Effective Customization Small organizations or R&D labs can prototype secure-by-design hardware without multi-million-dollar mask-set budgets-enabling wider adoption of hardware security in niche fields (medical devices, critical-infrastructure sensors, smart textiles)

A maturely developed system may have sufficient capacity, low cost, and write speeds to allow, where desired, ubiquitous integral recording of lossless compressed high resolution video with an infinite record life.

### 5. BRIEF DESCRIPTION OF DRAWINGS

FIGS. 1—3D ROM Printing Drive.

An overview of an embodiment of a 3D-Printed ROM making device. Such an embodiment may also contain electronic circuits to read the produced ROM allowing operation as a write one read many times drive

FIG. 2—Printer head Cross-Section

Shows a cross-section of an embodiment of a printer head, produced ROM and connecting base plate. Conductive, resistive and semiconductor materials are shown both in the printer head, and as deposited in the memory. Other parts shown including heating needles, ejection nozzles, and thermally insulating casing.

FIG. 3—Sphere Diode Matrix

Shows a cross-section of an embodiment of a part of a printer head, and produced ROM. This embodiment utilises placed spherical diodes in a diode matrix instead of the printed diodes shown inf FIG. 2.

FIG. 4—Fused Diode Matrix Memory

Shows an isometric perspective of an embodiment of a section of fused diode matrix memory. Fused diode matrix memory has a diode and blowable material in series at a connection point allowing the memory to be zeroed for security reasons.

FIG. 5—Secure Computing

Shows an embodiment utilizing 3D Printed ROM in a modern computer architecture for secure applications. Access to the ROM is restricted, and can only be accessed through the secure processor, or secure devices enclosed in secure casing.

FIG. 6—Data Verification across a Network

Shows an embodiment utilizing 3D Printed ROM to verify the authenticity of data across a network or after data storage between two devices. Dripping Nonce key pairs and hashing are used along with one or more secured servers.

FIG. 7—Private Key Encryption

Shows an embodiment utilizing Dripping Nonce key pairs as private keys to send encrypted data over a network.

FIG. 8—Secure ID Bracelet Key

Shows an embodiment utilizing Dripping Nonce Keys in a secure circuit that can be utilized for remote device and personal identification in field situation.

### 6. DETAILED DESCRIPTION

Detailed embodiments are disclosed herein; however, it is to be understood that the disclosed embodiments are merely exemplary implementations where many other embodiments may exist. Therefore, specific structural and functional details disclosed herein are not to be interpreted as limiting, but merely as a basis for the claims and as a representative basis for teaching one skilled in the art to variously employ the present disclosure in virtually any appropriately detailed structure.

This Detailed Description will use plain vernacular English with engineering jargon in places. Numerous modifications and adaptations will be readily apparent to those of skill in the art without departing from the spirit and scope of the disclosure. The purpose of the detailed description is to efficiently communicate concepts in an easy digestible and understandable way. The practicality of that purpose may result in statements that could be argued to be limiting the patent. Any such limitations are to be ignored.

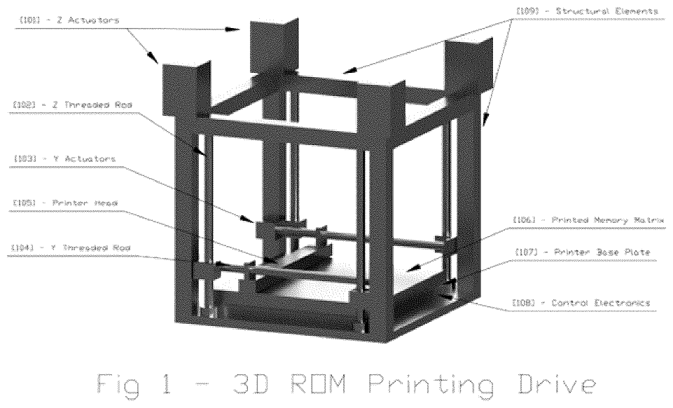

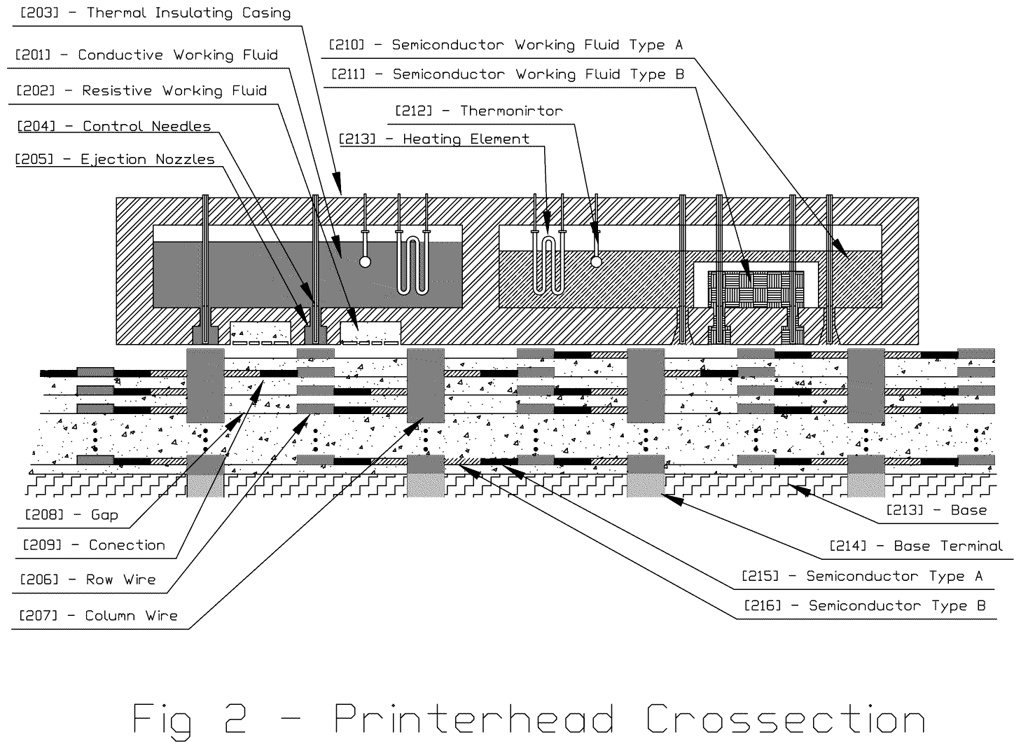

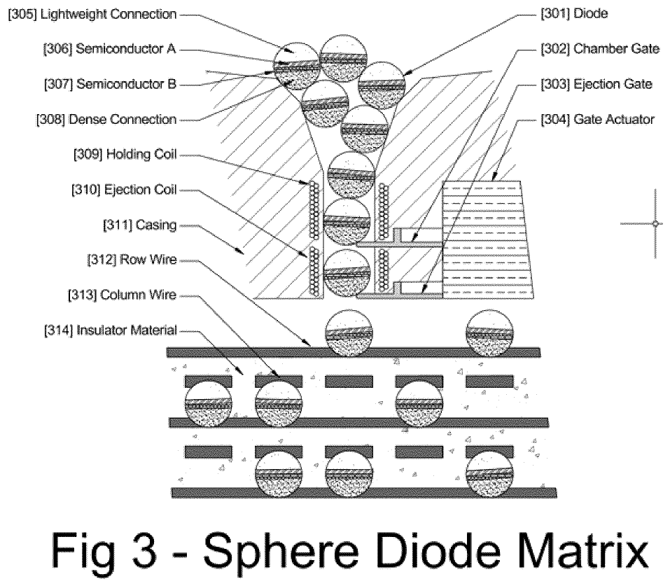

FIG. 1, FIG. 2, and FIG. 3 detail a 3D ROM Printing embodiments that in different configurations may or may not also possess the ability to read back written data. When the embodiment can read back written data, it is able to function as a Write Once Read Many Times non-volatile or persistent memory drive. Such an embodiment is typically currently used within a packaged computing system such as a personal computer or it may function separately on a communication network. In this capacity it serves well for secure data archiving.

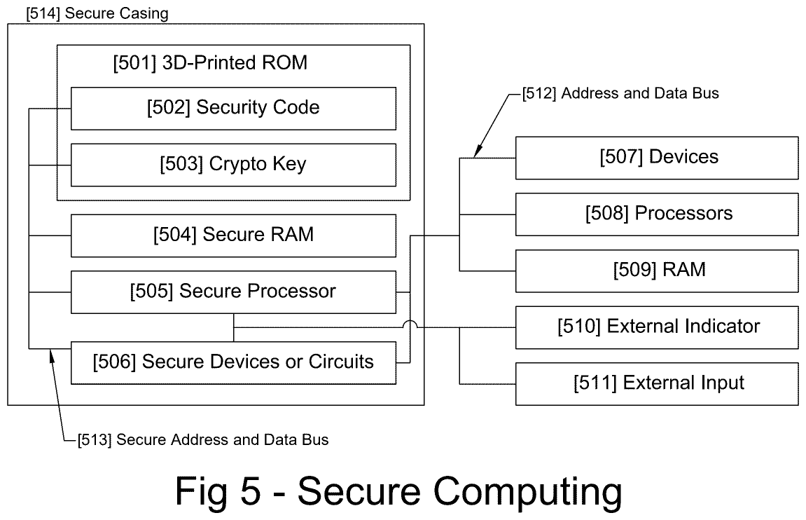

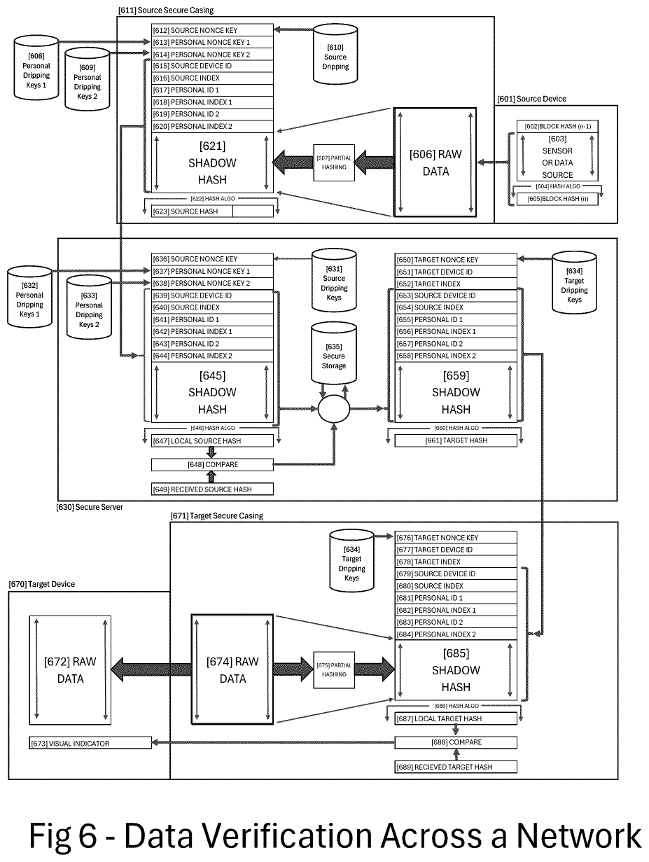

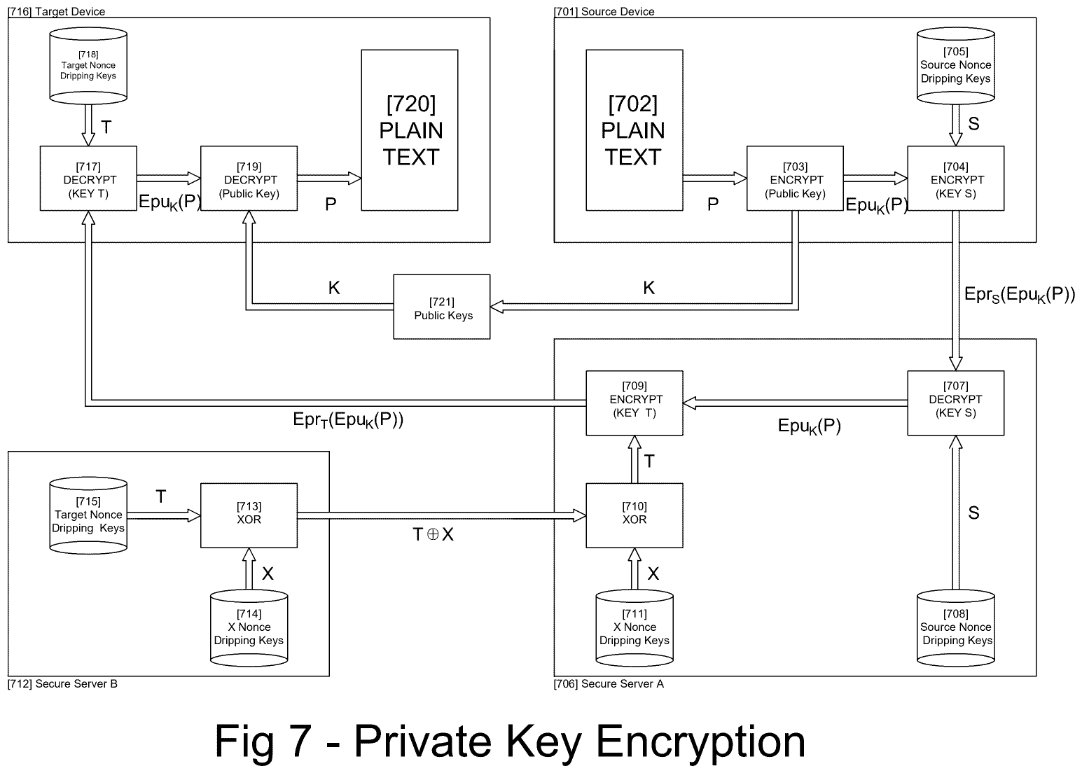

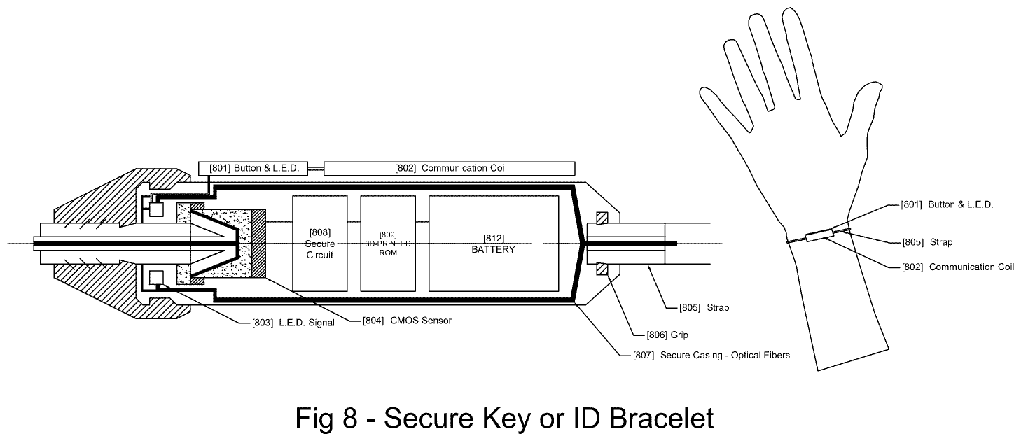

FIG. 5, FIG. 6, FIG. 7 and FIG. 8 discloses some cryptographic, hashing, and remote system identification applications that become practically deployable with produced single run 3D-Printed ROM. This is as opposed to other manufacturing methods that are more suited to producing a single templating tool, and from that many identical ROM units are produced.

### 6.1 FIG. 1—3D ROM Printing Drive

In one embodiment, the 101 Z Actuators are typically stepper motors that either directly or via gears, and or belts rotate the 102 Z Threaded Rod. Together this allows controlled positioning of the printer head in the vertical or Z-Dimension.

In this embodiment, 103 Y Actuators, and 104 Y Threaded Rod perform the same function but in the horizontal plane along one dimension herein named the Y dimension.

In this embodiment, the 105 Printer Head prepares and deposits materials to form the 106 Printed Memory Matrix. Typically, the printer head will have many repeating rows of nozzles. A Row being a series of nozzles in the Y Dimensions, and the Rows spanning across the 106 Printed Memory matrix, along the length of the printer head in the remaining dimension, typically referred to and herein named the X-Dimension.

In this embodiment a two-dimensional array of end terminals exists on the 107 Printer Base Plate. These conductive terminals allow for reading of ROM after production, and allow other production features during ROM writing. Terminals in the 107 Printer Base Plate are connected to the 108 Control Electronics to enable writing, automated quality control, and reading in the case of single drive device.

109 Structural Elements simply form a stiff frame to hold other components in place.

### 6.2 FIG. 2—Printhead Cross Section

With reference to FIG. 2, the printhead assembly comprises a 203 Thermally Insulating Casing that encloses fluid reservoirs: The 201 Conductive Working Fluid operates at high temperature to maintain a sufficiently reduced viscosity in working fluid. The 202 Resistive Working Fluid is much cooler than the 201 Conductive Working Fluid and assists in solidifying the conductive material. However, many variations on suitable 201 Conductive Working Fluids and 202 Resistive Working fluids exist, and their function with respect to this patent may not rely on thermal properties of the working fluids.

204 Control Needles manipulate the properties of the working fluids to control ejections of working fluids via the 205 Ejection Nozzles. Ejection is performed in a pattern that allows the represented data to be stored and read back.

207 Column Wires are each connected to a 215 Base Terminal. 207 Column Wires project up from the base through the Z-Dimension of the 206 Printed Memory Matrix.

206 Row Wires traverse across the horizontal plane along the X-Dimension.

The gapped intersection of 207 Colum Wires, and the 206 Row wires provides the location where either a 209 Connection representing a high bit or a 208 Gap representing a low bit can be created in the 206 Printed Memory Matrix. 216 Semiconductor Type A material and 217 Semiconductor Type B material ejected together in a controlled way bridge from the 207 Column Wires to 206 Row Wires and form a high bit 208 Connection. Other configurations may only use one type of semiconductive material, the semiconductor material may be incorporated into conductive materials, or another method of producing a diode, or sufficient asymmetric voltage to current flow characteristics.

A small portion, typically a row along the Y-Dimension of 207 Column Wires may be individually connected to all rows in a particular Z-Plane on the 206 Printed Memory Matrix. This allows addressing of that plane when reading data back from the 206 Printed Memory Matrix.

205 Ejection Nozzles may be many different shapes, and or have different liners to allow for use with different working fluid, and different functions including but not limited to:
1. A 205 Ejection Nozzle for printing 206 Row Wires may be larger, more elongated or even connected to adjacent 205 Ejection Nozzle for the same 206 Row Wire. Such a feature may allow a greater cross-section along the direction of flow of a reading electrical signal, and or increase reliability of continuity of a 206 Row Wire,
2. 205 Ejection Nozzles for 207 Column Wires may be more squarely shaped throughout, or perhaps at the base. This might increase reliability of connectivity, continuity of the wire through layers, or some other factor,
3. Some or all 205 Ejection Nozzles may be surrounded by an electrical terminal to ensure material has either spread out sufficiently, or to limit spreading out of material in the horizontal plane.

212 Heating Elements and 213 Thermostats are used in working fluids baths. 212 Heating Elements and 213 Thermostats would be most likely be used elsewhere also. 210 Semiconductor Working Fluid Type A and 211 Semiconductor Working Fluid Type B details are not specified as many variants exist. The semiconductor fluids may not necessarily semiconductors together may not form a perfect diode but may just have sufficient asymmetric voltage vs current properties.

A 214 Base Plate sits beneath the 206 Printed Matrix Memory with an array of 215 Base Terminals that form connection points between 207 Column Wires and 208 Control Electronics.

Many other arrangements of a memory matrix exist and reference to this exemplary embodiment should not limit the patent.

### 6.3 FIG. 3—Sphere Diode Matrix

With reference to FIG. 3, additive manufacturing techniques may include the printing or placing of partial or entire manufactured materials or electronic components. An embodiment uses 301 Diodes in the shape of spheres to build up the memory space.

The 301 Diodes Spheres are manufactured separately allowing for the controlled manufacture and associated increase in quality characteristics. The 301 Diode Spheres utilise a 305 Lightweight Connection composed of a low density electric conductive material such as Aluminium, or Zinc on one Hemisphere, and a 308 Dense Connection material such as Tungsten, or Lead on the other hemisphere with 306 307 Semiconductors materials sandwiched in-between. The difference in density of the connectors, and the spherical shape cause the diode to vertically orientate itself in suitable fluid typically with density slightly less to the average density of the 301 Diode Spheres.

Diodes find their way down towards the 302 Chamber Gate as 301 Diode Spheres ahead are placed into the memory space. Both the 302 Chamber Gate and the 304 Ejection Gate for many Nozzles are controlled by one or a small number of 304 Gate Actuators.

301 Diode Spheres are either held back or projected down by the 309 Holding Coil, and the 310 Ejection Coil when the 302 Chamber Gate and the 304 Ejection Gate are opened allowing controlled ejection of 301 Diode sphere into the Sphere Diode Matrix. The 309 Holding Coil, and the 310 Ejection Coil may be composed of a series of electrical coils, and may also be utilized to detect the presence and position of 301 Diode Spheres.

Two mechanical gates in sequence each with a controlling coil behind or above it increase control over the ejection of the diodes. The systems can confirm that a 301 Diode sphere is present or absent between the two gates utilising the 310 Ejection Coil prior to opening the gates decreasing the potential for misfires and the need for more error coding in the memory matrix.

The current bit being placed both drops down under gravity, and is projected or held back by the 310 Ejection Coil onto the memory matrix with the Column wire. The 310 Ejection Coil may also serve to heat the 301 Diode Sphere prior to placement.

If the next bit to be place after the bit currently being placed is low, the 309 Holding Coil is energised in a fashion that prevents the Diode Sphere from progressing to 302 Chamber Gate. If the next bit to be placed after the currently bit being placed is high, the 309 Holding Gate is either not energised, or energised in a fashion that assists propelling the diode down.

312 rows and 313 column wires are both in horizontal planes in the diode memory matrix allowing a more dense memory, but potentially slower read times as a row is read at one time instead of a layer in previously described embodiments.

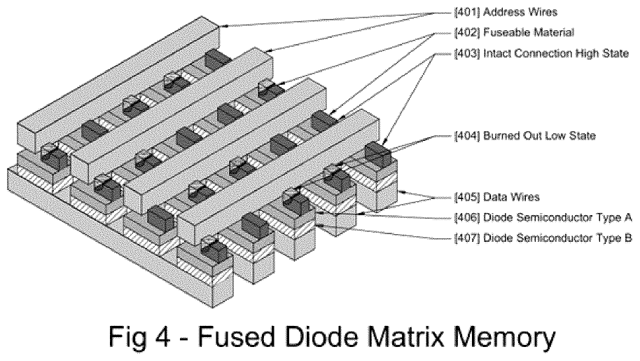

### 6.4 FIG. 4—Fused Diode Matrix

With reference to FIG. 4, the fused-diode memory array can be configured to implement writing-once read-once, Erasable Read only memory, Programmable Read Only Memory, Destroyable Read Only Memory, or other various combinations. The different configuration may require different controlling electronics.

In order to be able to zero data after it is read, or program memory in the case of PROM a fuse like material is placed in series with a diode at the connection.

406 Diode Semiconductor Type A, and 407 Diode Semiconductor Type B are printed in a manor that causes diode behaviour where both materials meet.

401 Address Wires and 405 Data Wires are similar to embodiments illustrated in FIG. 1 and Fing 2. The difference is that the 401 Address Wires and 405 Data Wires can also be used to supply a bit or set of bits a sufficiently high current or voltage for a sufficient period to burn out the 402 Fusible Material altering the state of the bit to zero. 403 Intact Connection High State illustrates a high or 1 state and 404 Burned Out Low State illustrates a burned-out low state.

Another configuration of this memory type only prints a diode and fuse at high connections intended to be high state. Then burn out the fuse after use. This provides the same functionality; however, a malicious party may disassemble the memory perhaps using a CNC machine to plane off successive layers, and would be able to determine the data that was stored. Various image techniques may also be utilised in attempting to read data after deletion. To thwart these attempts this embodiment has high and low bits prepared identically, and efforts to make fuses material blown while writing, and erasing.

Other configurations implement destroyable ROM, or PROM utilise insulative materials where state can be changed from inherit and stable to corrosive, or explosive.

### 6.5 FIG. 5—Secure Electronics and Computing

With reference to FIG. 5, a secure computing module is enclosed within a 514 Secure Casing that is often tamper-resistant. An example of a tamper-resistant system is described in patent U.S. Pat. No. 7,518,507 B2 using fibre optical, but other methods are available.

501 3D-Printined ROM is stored in 514 Secure Casing with access to a 505 Secure Processor, and 504 Secure RAM across a 513 Secure Address and Data Bus. Typically, the 501 3D-Printed ROM holds the startup code, all or part of the operating system, and all or parts of any secure applications it implements. The 501 3D-Printed ROM may also hold dripping nonce keys to facilitate security features. 506 Secure Devices, or Circuits may also be stored in the 512 Secure Casing to assist or facilitated features.

Communication with the devices outside the 514 Secure Casing is only possible either through the 505 Secure Processor, or 506 Secure Devices or Circuits. Both methods of communication implementing secure protocols for communication. Direct communication with users is hardwired directly to the 505 Secure Processor or the 506 Secure Devices or Circuits. These hardwired components are illustrated as the 510 External Indicator, and 511 External Input are not programmable by programs or systems outside the Secure Casing and so form a more secure form of communication between the user and the secure computing system provided they are manufactured correctly and not tampered with.

In one configuration the 510 External Indicator could be an L.E.D. that indicates the Secure Computer had control of a portion of a larger systems display screen. Information in that portion of the screen can then be considered secure, and information contained within it can be trusted provide the device has not been adapted in a way that would be difficult to conceal.

The same configuration may have the 511 External Input simply as a button to confirm information in the secure section of the screen, or allow a request presented in the secure section of a screen.

In another configuration typically where the device has limited functional requirements the 505 Secure Processor, and 504 Secure Ram may be omitted or replace with Secure Circuits. Such a configuration is referred to as Secure Electronics instead of Secure Computing.

Another configuration could retain all the features of a modern device such as a mobile phone, or personal computer, with added security features. Communication between external 507 Devices, and a larger 509 RAM as used in such devices can be facilitated as normal with the external 512 Address and Data Busses.

### 6.6 FIG. 6—Data Verification Across a Network

With reference to FIG. 6, one embodiment relates to Data Validation over a network or after storage between a 601 Source Device, and a 670 Target Device. Both the 601 Source Device, and the 670 Target Device are connected to a network with a trusted 630 Secure Server also connected and addressable.

Data Validation is achieved utilising hashing and dripping nonce key pairs individually between the 601 Source Device and the 630 Secure Server, and separately between the 630 Secure Server, and 670 the Target Device with traceability.

A sequence of steps is listed directly below and numbered to verify or authenticate data across a network for the configuration illustrated in FIG. 6.
1. The 601 Source Device collects or prepares 603 Sensor or Source Data. The 603 Sensor or Source Data may contain a 605 Block Hash created using 604 Hashing Algorithm and 602 Block Hash from previous data to ensure continuity. Not shown in FIG. 6, but other configurations may also contain timestamps, location stamps, or other identification, or meta data.
2. The 603 Sensor or Source Data along with 605 Block Hash and any other meta data are now considered 606 Raw Data to be transmitted or stored, and requiring validation on 670 Secure Server. The 603 Sensor or Source Data may require being physically copied to a memory medium inside the 611 Source Secure Casing if the 601 Source Device is not incorporated inside the 611 Source Secure Casing.
3. 606 Raw Data can be 607 Partially Hashed to a 621 Shadow Hash. This reduces the size of the data required to be transmitted, processed, and stored on the 630 Secure Server.
4. A nonce key is released from the 610 Source Dripping Keys and inserted block as seen 912 Source Nonce Key. A unique identifier named the 615 Source ID, usually a serial number, and the index of the 912 Source Nonce Key named the 916 Source Index are also inserted. Other Nonce keys may also be inserted. FIG. 6 shows two such keys, 609 Personal Dripping Keys 1, and 610 Personal Dripping Keys 2. Their indexes 618 Personal Index 1 and 620 Personal Index 2 along with personal identification numbers 617 Personal ID 1 and 619 Personal ID 2 are also included.
5. The 621 Shadow Hash is added to the block and further hashed using a 622 Hash Algo to produce the 623 Source Hash. Stripped of Nonce keys but retaining indexes, and unique ID numbers the message is transmitted across the public network to the 630 Secure Server. Separately the 606 Raw Data may be transmitted to the 670 Target Device or stored somewhere for later use.
6. The 630 Secure Server receives the 649 Source Hash, the 645 Shadow Hash, 639 641 643 Unique Identification Numbers, and 640 642 644 Indexes without 636 637 638 Nonce Keys.
7. The Hash is recomputed using 646 Hash Algo on the 630 Secure Server by reconstructing a logically identical block from both the received data, local data and potentially data received security from elsewhere to get the 647 Local Source Hash. Each part of the block with sufficient detail to describe function is listed directly below for easy of reference:
   1. 636 Source Nonce Key. Not Transmitted. Identical Opposite Nonce Key sourced from 631 Source Dripping Nonce Keys on 630 Secure Server using received 639 Source Device ID and 640 Source Index.
   2. 637 Personal Nonce 1. Not Transmitted, and not on the 630 Secure Server. 635 Personal Nonce 1 must be securely received from a server that contains it using 641 Personal ID 1 and 642 Personal Index 1 to locate it. See 714 711 X Key dripping key pair in FIG. 7. for more details on a secure transmission method.
   3. 638 Personal Nonce Key 2. Not Transmitted. Identical Opposite Nonce Key sourced from 633 Source Dripping Keys 2 on 630 Secure Server using received 643 Personal ID 2 and 644 Personal Index 2.
   4. 639 Source Device ID, 640 Source Index, 641 Personal ID 1, 642 Personal Index 1, 643 Personal ID 2, 644 Personal Index 2, and the 645 Shadow Hash, are also received.
8. The listed items are hashed into 647 Local Source Hash and 648 Compared to the received 649 Received Source Hash. If the hashes are identically the 645 Shadow Hash is considered authentic by the 630 Secure Server, and along with all the other details is send to 635 Secure Storage. A 3D-Printed ROM drive with minimally block chained for traceability is suitable for 635 Secure Storage.
9. Immediately after secure server authentication, or when data is required to be verified on the 670 Target Device, a similar validation process to that so far is repeated, this time from the 630 Secure Server to the 670 Target Device. A 650 Target Nonce key, and its index is received from the 634 Target Dripping keys. A 661 Target Hash is computed with 660 Hash Algorithm using the following list for block data: 650 Target Nonce key; 651 Target Device ID; 652 Target Index; 653 Source Device ID; 654 Source Index; 655 Personal ID 1; 655 Personal Index 1; 657 Personal ID 2; 658 Personal Index 2; and 659 Shadow Hash. This list without the 650 Target Nonce is then transmitted to the 670 Target device along with the 661 Target Hash.
10. The target hash is recomputed on the 670 Target Device by reconstructing a logically identical block from both the received data, and local data. Each part of that block with sufficient detail to describe function is listed directly below for ease of reference:
   1. 676 Target Nonce Key. Not Transmitted. Sourced from 634 Target Dripping Keys on 670 Target Device using received 677 Target Device ID and 678 Target Index.
   2. 677 Target Device ID, 678 Target Index, 679 Source Device ID, 680 Source Index, 681 Personal ID 1, 682 Personal Index 1, 683 Personal ID 2, 684 Personal Index 2, and the 685 Shadow Hash, are also received.
   3. The 674 Raw Data being verified is received and 675 partially hashed to produce the 685 Shadow Hash for the target.

The listed items are hashed into 687 Local Target Hash and 688 Compared to the 689 Received Target Hash. If the hashes are identically 674 Raw Data is considered authentic by the Target Server.

Depending in the configuration the 694 Raw data is then free to be displayed or used in the 670 target device outside the 691 Target Secure Casing. Typically, a separately hardwired 673 visual indicator verifies the data is authentic or the state and extent of authentication.

### 6.7 FIG. 7—Private Key Encryption

With reference to FIG. 7, private-key encryption over a network between a 701 Source Device, and a 716 Target device requiring 706 712 Secure Servers.

Pairs of Identical Dripping Nonce Keys are used to encrypt and decrypt the message. This configuration has a layer of public key encryption beneath the private key encryption. Other configurations may not include this public key encryption layer.

The configuration illustrated in FIG. 7 is outlined as a numbered sequence of steps is directly below.
1. 702 Plan Text P maybe encrypted by other means prior to Private Key Encryption. FIG. 7 first sets up a 721 Public Key K and 703 Encrypts the 702 Plain Text. 704 Private Key encryption is performed with Key S from from the 705 Source Dripping Nonce Key paired with opposite, and often identical 708 Source Nonce Dripping Keys on 706 Secure Server A. The cypher text is then sent to 706 Secure Server A.
2. 706 Secure Server A does not hold the 715 Target Nonce Dripping Keys, but does contained 711 X Nonce Dripping Keys that are the opposite set of dripping keys to 714 Nonce Dripping Keys X, on 712 Secure Server B, where the 715 Target Nonce Dripping Keys are contained. A Key T from 715 Target Nonce Dripping keys is XORed with a Key X from 714 X Nonce Dripping Keys. The result X⊗T is then passed from 712 Secure Server B to 706 Secure Sever A where it is 711 decrypted or in this case xor'ed using key X from 711 X Nonce Dripping Keys, and now available on 712 Secure Server B.
3. The Encrypted message from the 701 Source Device is 707 Decrypted on 706 Secure Server A using Key S from 708 Source Nonce Dripping Keys. It is then 709 encrypted with Key T, and sent to the 716 Target Device.
4. The 716 Target Device 717 Decrypts the message using Key T taken locally from 718 Nonce Dripping Keys. In this configuration the message is then further 719 decrypted using public key methods to visible 720 plain text P.

This configuration shows the passing of the encrypted message to a 706 Secure Server that then receives the 710 Target Private Key from another server 712 Secure Server B. This means the Private Key Encryption layer is completely removed in 706 Secure Server A. While in this configuration public key encryption remains, this is a vulnerability.

It is possible that governments, religious, fraternal groups, guilds and intelligence agencies have decided to deploy encryption methods in publicly available products they can overcome, often referred to as a back door. This questionable feature can be implemented in this configuration. The backdoor in this case being 706 Secure Server A, assuming that such groups can overcome the public key encryption. In another configuration the target private key T could be sent securely to the source device allowing complete encryption between devices. Disallowing such configurations methods of encryption can be performed by legal means, regulation, and international treaty in public view.

### 6.8 FIG. 8—Personal Id and Door Locking System

Another embodiment has a small secure computer device with several features. The system uses L.E.D.s, fibre optics, or light pipes, and CMOS sensors to implement a security casing around the secure device. Data Communication is by a 802 Radio Frequence coil that could also assist with providing electrical potential to the system. Operator communication is via a simple 801 Button and L.E.D. 808 Secure Circuits provide functionality, handle power requirements, and manage access to 3D Printed ROM. A 812 Battery allows the secure casing to continuously operate and allows more smooth operation of the device.

A 806 grip holds an inelastic 806 strap in place making it very difficult to remove without the person wearing it being consciously aware of its removal.

Different configurations allow a range of protocols and functions for such a device including those listed directly below:
1. On site personal identification using pairs of dripping keys. One side of a dripping key could be used to identify the device and therefore the person wearing it. This could form part of a multi-step personal identification system;
2. FIG. 6 incorporates personal verification but does not describe an infield system for deploying. This system could provide that functionality;
3. Protocols or functions requiring secure personal confirmation just as payments, document revision, command verification;
4. protocols to allow wears open automated door locking systems quickly and with little effort.

Another configuration of this embodiment without the bracelet could be used on products or parcels. Place on or inside products the device can be identified and tracked allowing verification of authenticity at any point along the supply chain with access to the Internet.

### 7. OPERATION

### 7.1 Write Once Read Many Times Drive

To write to ROM, a write protocol is initiated from an external device. In line with the protocol data to be written is sent. The data is recorded in the 106 Printed Memory Matrix as a diode memory matrix.

To read from ROM, a read protocol is initiated from an external device. In Line with the protocol data is received from the ROM. The data is read from the Printed Memory matrix.

### 7.2 Secure Computing and Secure Electronics

Use device as instructed using any hardwired visual aid to alert you of security features engagement, concerns, or tamper issues. Periodically contact supplier or security administrator by separate means especially after any suspicious activity, or prior to high risk secure activities.

### 7.3 PROGRAMMABLE ROM

To program the ROM, a program protocol is initiated from an external device. In line with the protocol data is written by burning out fusible material in the ROM.

### 7.4 Erasable ROM

To erase a section of ROM, a erase protocol is initiated from an external device. In line with the protocol data is erased by burning out fusible material in all high states bits on the section of the ROM.

### 7.5 Destroyable ROM

To Destroy ROM, call the destroy function on the system controlling the destroyable ROM, and the state of the filling medium will be changed to destructive or corrosive.

### 7.6 Data Validation

Use device as instructed using any hardwired visual aid to alert you of validity of data presented. Periodically contact supplier or security administrator by separate means especially after any suspicious activity, or prior to high-risk secure activities

### 7.7 Encryption

Use device as instructed using any hardwired visual aid to alert you of security of data sent or received. Periodically contact supplier or security administrator by separate means especially after any suspicious activity, or prior to high-risk secure activities

### 7.8 Secure Personal Identification Bracelet

Use device as instructed using any hardwired visual aid to alert you of security of data sent or received. Periodically contact supplier or security administrator by separate means especially after any suspicious activity, or prior to high-risk secure activities.

What is claimed is:

1. A write-once, read-many times (WORM) data storage medium manufactured using one or more automated manufacturing techniques selected from the group consisting of 3D printing, additive manufacturing, digital manufacturing, on-demand manufacturing, robotic process automation, hybrid manufacturing, or equivalents thereof, the storage medium comprising:
(a) a plurality of address bit line connectors, capable of transmitting a binary state;
(b) a plurality of data bit line connectors, capable of transmitting a value state;
(c) a plurality of intersecting regions where respective address bit line connectors and data bit line connectors are in close proximity to one another but not in direct physical or electrical contact;
(d) a plurality of memory cells disposed at said intersecting regions, each memory cell being contiguous with one of said address bit line connectors and one of said data bit line connectors, and configured to transmit a stored memory value to the corresponding data bit line connector when the associated address bit line connector is transmitting a high binary state; and
(e) a means to read the state of every said memory cell by setting the set of said address bit line connectors transmitted states to various different patterns and reading the transmitted values of said data connector lines,
whereby one-time, low-volume, or mass runs of identical read only memory can be created.

2. The data storage medium of claim 1 comprising one or more of:
(a) address wires being said address bit line connectors in sections between contiguous said memory cells, and arranged running in straight lines parallel to each other in three-dimensional space;
(b) data wires being said data bit line connectors in sections between contiguous said memory cells, and arranged running in straight lines parallel to each other in three-dimensional space;
(c) a three-dimensional matrix consisting of a series of parallel planes wherein alternate parallel planes contain a multitude of said address wires, and a multitude of said data wires oriented and typically perpendicular to said address wires when said matrix is viewed in orthographic projection perpendicular to any plane in said series of parallel planes;
(d) said address wires, and said data wires capable of transmitting electrical current, light, or any electromagnetically signal to convey a state;
(e) said memory cells capable of maintaining readable memory states by means of one or more physical principles selected from: asymmetric current transitions (diode behaviour), capacitance, inductance, resistance, transistor behaviour, optical or electromagnetic signal interference, or other signal-modulating mechanism;
(f) a structural filler material occupying the space in the 3D matrix not taken up by said address wires, data wires, or memory cells, said filler optionally functioning as an electrical insulator and/or provides a mechanical scaffolding carrier matrix binding substrate for functional parts; and
(g) said address wires, data wires, and memory cells being composed of any suitable combination of materials or components, including but not limited to solids, liquid, gases, or other material phase, metal, metal alloys, ceramics, polymers, glass, semi-conductors, organic semiconductors, nanoparticles, composites, emulsions, Pickering emulsions, microemulsions, nanoemulsions, suspensions, colloids, foams, gels, aerogels, aerosols, phase-changing materials, photonic, magnetic, organic, electrical electronic or optical components, inkjet materials, materials containing chemical additive or any other functional material,
whereby device operation characteristics such as access speed, quality, and memory density are improved to practical levels.

3. The data storage medium of claim 2 further comprising one or more of the following:
(a) A means to blow a memory cell by including a fuse or more descriptively inserting a section of matter that can be unidirectionally altered from conductive to isolating in series with the section providing a means of holding readable memory state;
(b) A means to erase an addressable memory area, by simultaneously blowing or zeroing all fuses within an addressable group;
(c) A means to program the storage medium, by blowing individually addressable memory cells similar to a write once feature;
(d) A means to make an addressable area immutable, by preventing any further erasing, or programming in an addressable memory area;
(e) A means to limit an addressable area erasable read only memory, by preventing any further programming in an addressable area;
(f) A means to destroy memory, by altering said structural filler material from an inert or isolating material into an active state capable of physically destroying or electrically disabling adjacent memory cells and/or wires, thereby enabling a secure data destruction or tamper resistance feature; and
(g) Control circuitry configured to enable none, one, or any combination of the above features,
whereby the write once read many times nature of the data storage medium is expanded to allow implementation of many memory types for different application requirements including but not limited to read only memory (ROM), write-once read many-times (WORM), write-once read-once (WORO), programmable read only memory (PROM), erasable programmable read-only memory (EPROM), and destroyable memory.

4. A secure electronic or computing device enveloped in secure casing with restricted external communication, comprising:
(a) One or more processors configured to execute instructions, wherein any processor capable of performing operations that pose a security risk to predefined security requirements is located entirely within the secure casing;
(b) One or more memory units storing startup instructions, portions of an operating system, or any other executable code that could pose a security risk if modified, wherein such memory is located within the secure casing;
(c) Any instructions that, if altered, could compromise security, stored on read-only memory (ROM) positioned inside the secure casing;
(d) Any volatile memory that, if read or altered by a malicious actor, could pose a security risk, wherein such volatile memory is located within the secure casing;
(e) Any circuitry or devices that, if modified or functionally altered, could pose a security risk, wherein such circuitry or devices are contained within the secure casing;
(f) Any Internal communication buses or interfaces between processors, memory (volatile or non-volatile), and circuitry are confined entirely within the secure casing, without accessible communication paths to external components unless explicitly controlled by secure logic; and
(g) External communication buses or interfaces are limited to connections that either (i) interact only with the internal processor under control of security-assured code, or (ii) interface only with external circuits or devices that enforce the specified security requirements,
whereby secure computing functionality compliant with predefined security specifications is achieved.

5. The system of claim 4 wherein the device individually, in pairs, or in groups incorporates said data storage medium as described in claim 3, the system comprising:
(a) A data storage medium partitioned into a plurality of functional segments, each referred to as a “key”, wherein the keys are either sequentially accessible or indexed for retrieval;
(b) In the case of an individual device the data storage device contains unique randomly generated data;
(c) In a pair or group of devices, corresponding keys at the same sequential position or index across the devices form a “set of opposite keys”, wherein each set of opposite keys contains values intended to fulfil a predefined cryptographic function or operational purpose, and may comprise identical randomly generated values across devices;
(d) a means to restrict access to unread keys based on predefined external factors or timing conditions, wherein such restricted-access keys are referred to as “dripping keys”; and wherein pairs or groups of devices utilizing sets of opposite keys with such constraints are referred to as a “pair of dripping keys” or a “group of dripping keys”, respectively;
(e) a means to limit or prevent repeated access to previously read keys in a manner consistent with the function of the system;
(f) The random and unique nature of the data stored in the keys is of sufficient unpredictability that no malicious actor can infer or exploit identical sequences or numerical patterns in the dataset to compromise the system's intended function,
whereby individual, paired, or grouped keys and dripping keys are suitable for use as random values, one-time-use (nonce) keys, private encryption keys, hashing keys, block-hashing keys, personal or device identification or authentication keys, digital signature keys, or other cryptographically functional keys.

6. The system of claim 5 wherein three network-connected secure devices herein named the source device, the validation device, and the target device, utilize two pairs of identical dripping keys, wherein the keys in the first pair are referred to as the source validation key and the keys in the second pair as the target validation key, for validating transmitted raw data, the system comprising:
(a) a means for generating an authentication hash, herein referred to as a shadow hash, from large volumes of raw data, the shadow hash being significantly smaller in size than the raw data yet substantially larger than typical cryptographic hashes, such that it is resilient against practical brute-force or collision attacks, and is of a size suitable for long-term storage and efficient transmission;
(b) a means for generating a validation hash by concatenating the shadow hash with a private validation key and applying a cryptographic hash function to the concatenated result, wherein the validation hash is transmittable along with the shadow hash over a public network, and is verifiable on a receiving device possessing the opposite private validation key;
(c) The communication network facilitating data exchange among the source device, validation device, and target device;
(d) The source device, configured to generate or transmit raw data, comprising:
A connection to the communication network;
A system that produces raw data that requiring validation as authentic on the target device after being transmitted across a public network, and potentially after long term storage on an unknown device connected to the communication network;
A means of computing the shadow hash from raw data herein called the source shadow hash;
The source validation key being a key from the first of the pair of identical dripping keys;
A means of computing a source validation hash using the source shadow hash and the source validation key;
A means of transmitting the source shadow hash and the source validation hash to the validating device;
(e) The validating device configured to be the trusted server for validation comprising:
A connection to the communication network;
a secure copy of, or secure access to, both the source validation key and the target validation key;
a means for recomputing the source validation hash from the received source shadow hash and the locally sourced source validation key for comparison against the received source validation hash to authenticate the source shadow hash.
Secure data storage to facilitate retaining authenticated source shadow hashes
A means of computing a target validation hash using the locally sourced target validation key and received to authenticated securely stored source shadow hash
A means of transmitting the source shadow hash and the target validation key to the target device;
(f) A target device, configured to receive raw data to be authenticated, the source shadow hash, and the target validation hash comprising:
A means of computing the shadow hash;
A secure copy of the target validation key;
A means of authenticating the source shadow hash by hashing the target validation key and received source shadow hash and comparing the result to the received target validation hash;
A means for authenticing receiving raw data, by computing its shadow hash and comparing it to the authenticated received shadow hash;
a visual or hardware-based, non-programmable output mechanism for indicating whether the current data on the target device is authentic,
whereby raw data transmitted from the source device can be validated as authentic or identical upon reception at the target device.

7. The system of claim 5, wherein three or more network-connected secure devices-herein referred to as the source device, validation device, and target device-utilize two pairs of identical derived cryptographic keys, wherein the keys in the first pair are referred to as the source encryption key and the keys in the second pair as the target encryption key, for securely transmitting encrypted messages, the system comprising:
(a) a means for encrypting a message using a private encryption key, such that the encrypted message is resistant to decryption without access to the corresponding key, and is suitable for secure transmission over a public or untrusted network;
(b) a means for decrypting the encrypted message using the corresponding private encryption key from the identical pair, such that the original message is recoverable only by a device in possession of that key;
(c) a communication network facilitating secure data exchange among the source device, validation device, and target device;
(d) a source device configured to generate and transmit a secure message, comprising:
a connection to the communication network;
a system for generating the message to be encrypted and transmitted;
a private key from the first pair of identical keys, herein referred to as the source encryption key;
a means for encrypting the message using the source encryption key;
a means for transmitting the encrypted message and optionally associated metadata to the validation device;
(e) a validation device configured as a trusted server for secure message handling, comprising:
a connection to the communication network;
a secure copy of, or secure access to, both the source encryption key and the target encryption key;
a means for decrypting the received encrypted message using the source encryption key to verify its origin or content;
a means for re-encrypting the decrypted message using the target encryption key for secure delivery to the target device;
(f) a target device configured to receive and decrypt secure messages, comprising:
a secure copy of the target encryption key;
a means for decrypting the received message using the target encryption key to recover the original message content;
a means for securely displaying, storing, or acting on the decrypted message;
a non-programmable, hardware- or visual-based mechanism for verifying the authenticity or integrity of the message as received on the device,
whereby a message transmitted from the source device can be securely and confidentially delivered across a network, optionally with intermediary validation, and decrypted only by the intended target device.

8. The system of claim 5, wherein two communicating secure devices-herein referred to as the ID claimant device, and ID authenticator device utilize a pairs of time constricted identical dripping keys to verify the identity of the ID claimant device comprising:
(a) ID claimant device configured to be able to verify its identity and integrity comprising:
a means for initiating an identity verification request by alerting the ID authenticator device and transmitting a unique identifier or serial number;
a means for retrieving one or more previously unused keys from a set of time-constrained identical dripping keys based on an index or plurality of indexes received from the ID authenticator device, and transmitting the corresponding key(s) in response;
(b) The ID authenticator device, configured to verify the identity of the ID claimant device, comprising:
a means for receiving an identity verification request and the associated unique identifier or serial number from the claimant device;
a means for selecting an index or plurality of indexes corresponding to one or more previously unused keys from the time-constrained key sequence;
a means for transmitting the selected index(es) to the ID claimant device and receiving the corresponding key(s) in return
a means for retrieving the expected key(s) from the local copy of the time-constrained dripping keys and comparing them with the received key(s)
a time-bound constraint on the interval between index transmission and key receipt to reduce the risk of man-in-the-middle attacks,
whereby the identity and integrity of the ID claimant device can be securely verified using ephemeral, time-sensitive symmetric key pairs.

9. The system of claim 8 further comprising one or more of:
(a) A simple interface to indicate a request, and the ability to initiate a response such as a button and an L.E.D;
(b) A means or protocol to either or both, receive or transmit a range of key values to an external device to be utilised as future validation of communicating with the same device; and
(c) A means to record received values to be used to verify identity of transmitting device in future,
whereby remote device or personal identification authentication is facilitated with a convenient, simple, and securely confirmation interface for use in automated door locks, in field battle systems, or other systems where authentication is required without guaranteed access to secure server.

10. A means to create the data storage medium of claim 1, wherein said data storage medium is fabricated using:
(a) one or more automated manufacturing techniques selected from the group consisting of 3D-printing, additive manufacturing, digital manufacturing, on-demand manufacturing, robotic process automation, hybrid manufacturing, or equivalents thereof, to produce said address bit line connectors and said data bit line connectors; and
(b) one or more of said automated manufacturing techniques to selectively form electrical connections or isolations at said intersecting regions between address bit line connectors and data bit line connectors, such that said formations result in readable memory cells configured to output fixed memory states in response to signals on said address bit line connectors.

11. The system of claim 10, further comprising a data writing apparatus configured to manufacture the data storage medium, the system comprising:
(a) a structural frame and protective casing enclosing said end effectors, positioning actuators, data storage medium, controlling electronics, and related components;
(b) positioning actuators configured to accurately position said end effectors in three-dimensional space;
(c) one or more end effectors equipped with a plurality of depositing mechanisms capable of delivering and fusing materials or components onto the memory medium to form address wires, data wires, and memory cells with properties as described in claim 2 or claim 3;
(d) depositing mechanisms comprising one or more of:
3D-printing nozzles; additive manufacturing elements; pick and place manufacturing elements; digital manufacturing; on-demand manufacturing,
conductive nozzle centreline needles capable of heating, charging, or vibrating,
active mechanisms including pick and place, mechanical valves, or openings; inkjets; rolling on preconstructed layers,
electromagnetic induction elements, including induction coils and electrical terminals or rings, configured to manipulate or monitor the deposition process or material properties including temperature, eddy currents, static charges, position or presence of material, and or velocity,
processes similar to welding;
(e) environmental and material controls comprising one or more of:
static charge; heating elements and temperature sensors; UV or other wavelength L.E.D.s or other electromagnetic wave source; atmospheric pressure and composition regulation to ensure fidelity of the deposited materials or memory cell formation,
fluid velocity sensors; acoustic or mechanical vibration; signal generation and control systems capable of applying direct or alternating current, static electric charge, or electromagnetic waves to influence the behaviour of deposited or fusing materials, including altering viscosity, phase, charge, or controlling oxidation rate or other process, and
feedback and sensing systems including electronic sensors, cameras with optics, thermometer;
(f) control circuitry configured to coordinate deposition, environmental modulation, energy delivery, and feedback mechanisms during the fabrication of the memory medium,
whereby said apparatus enables the formation of three-dimensional data storage media with memory cells operable by the physical principles described in claim 2 or claim 3, including but not limited to diode behaviour, capacitance, resistance, optical or electromagnetic interference.

12. The system of claim 11 whereby a means to read data medium are incorporated into the data writing apparatus resulting in a write once read many times memory storage drive.

13. The system of claim 6 further comprising one or more of:
(a) Block-chaining or using the storage system of claim 11 to secure validity of data revisions; and
(b) The system of claim 12 to provide a means to record revisions, personal validation of revisions,
whereby document, record, or recording revision management system can be implemented.

14. The system of claim 4 further comprising one or more of:
(a) A functioning operating system;
(b) The system of claim 6 to provide data validation;
(c) The systems of claim 7 to provide encryption;
(d) The systems of claim 8 to provide personal, remote device, or product Identification; and
(e) Keyboard, mouse, visual display unit or other expected IO devices in a secure manner,
whereby a secure personal computer, mobile device, mobile phones, other personal electronic device or electronic device can be constructed.

15. The system of claim 14 further comprising one or more of:
(a) The system of claim 12 to provide a means to record immutable documents, records or recordings; and
(b) The system of claim 13 to provide a means to record revisions, personal validation of revisions,
whereby a secure record management system is developed.

16. A plurality of the systems of claim 14, further comprising intermittent or continuous connections between them with protocols to implement functions,
whereby a secure computing ecosystem can be created, supporting a wide range of applications and services.
